(19) United States
(12) Patent Application Publication
(10) Pub. No.: US 2008/0183722 A1
(43) Pub. Date: Jul. 31, 2008

(54) Registration System

(76) Inventors: Robert Lane, Brighton (AU); Mark Suhr, South Yarra (AU)

Correspondence Address: DLA PIPER US LLP, 1999 AVENUE OF THE STARS, SUITE 400, LOS ANGELES, CA, 90067-6023, US

(21) Appl. No.: 11/577,000

(22) PCT Filed: Oct. 11, 2005
(86) PCT No.: PCT/AU05/01560

§ 371 Date: Jan. 2, 2008

(30) Foreign Application Priority Data
Oct. 13, 2004 (AU) 2004905903
Nov. 18, 2004 (AU) 2004906574
Mar. 4, 2005 (AU) 2005901038

(51) Int. Cl. G06F 17/30; H04L 9/32; G06K 19/06; B41J 11/44

(52) U.S. Cl. 707/100; 380/277; 235/492; 400/76; 707/E17.009

(57) ABSTRACT

A method of providing a registration label for a vehicle. The method includes determining registration information, the registration information being at least partially indicative of an identity of the vehicle; and then using the information to generate the label by causing printed information to be provided on the label, and by causing tag data to be stored in a tag data store. The printed information and tag data are at least partially indicative of the registration information so that the registration information can be checked by a suitable reader once the label is attached to the associated vehicle.

### BACKGROUND OF THE INVENTION

The present invention relates to a method and apparatus for use in asset registration, and in particular to an RFID type system used for use in vehicle registration.

### DESCRIPTION OF THE ART

The reference to any prior art in this specification is not, and should not be taken as, an acknowledgment or any form of suggestion that the prior art forms part of the common general knowledge.

Currently there is a need to be able to accurately identify and determine information relating to vehicles such as automobiles. This includes the ability to uniquely identify the vehicle, as well as to ensure that the vehicle is legitimately registered with relevant authorities.

Currently, vehicle identification is typically achieved using serial numbers engraved on the chassis or other locations. However, such information is often difficult to locate, and additionally cannot be altered, thereby making this suitable only for long term identification.

However, in registration type situations, it is typical for information to require updating on a regular basis, such as when vehicle ownership is transferred, or when the vehicle registration is renewed. This is therefore typically achieved using a sticker that is provided on the vehicle windscreen, or the like. However, such an arrangement only allows limited information to be provided, and it is typically relatively simple to replace or modify the labels making them of only limited value.

RFID (Radio Frequency ID) Systems are known for use in product identification or the like. Such systems utilize a tag having a processor and associated antenna. In use, data is stored in the tag by the processor, allowing the data to be subsequently retrieved by a suitable reader. To achieve this, the reader generates a signal that inductively couples the tag to the reader. This allows power to be supplied to the tag processor, which in turn uses backscatter modulation of the read signal to allow information to be transmitted to the reader. Active tags are also known, which incorporate a power source, and therefore are typically capable of communicating over a greater range than the passive tags described above.

SUMMARY OF THE PRESENT INVENTION

In a first broad form the present invention provides a method of providing a registration label for a vehicle, the method including, in a processing system:
a) determining registration information, the registration information being at least partially indicative of an identity of the vehicle; and,
b) generating the label by:
   i) causing printed information to be provided on the label, the label including a tag having a tag data store, and the printed information being at least partially indicative of the registration information; and,
   ii) causing tag data to be stored in the tag data store, the tag data being at least partially indicative of the registration information, the label being provided to allow the label to be attached to the vehicle, thereby allowing at least some of the tag data to be retrieved from the label using a suitable reader.

Typically the method includes, in the processing system, locking the tag data to thereby prevent subsequent alteration of the tag data.

Typically the method includes, in the processing system, generating the tag data by encrypting at least part of the registration information such that the tag data can only be decrypted using a predetermined secret key.

Typically the method includes, in the processing system:
a) determining a secret key associated with the registration information; and,
b) generating the tag data using the registration information and the secret key.

Typically the method includes, in the processing system:
a) determining an operator identifier indicative of an identity of an operator;
b) authenticating the operator using the operator identifier; and,
c) generating the label in response to a successful authentication.

Typically the method includes, in the processing system:
a) receiving the operator identifier from the operator;
b) comparing the operator identifier to a number of predetermined operator identifiers stored in a database; and,
c) authenticating the operator in response to a successful comparison.

Typically the operator identifier includes at least one of:
a) a biometric signature;
b) a password; and,
c) a PIN.

Typically the method includes, in the processing system:
a) determining at least one access level associated with the registration information; and,
b) generating tag data in accordance with at least one access level.

Typically the method includes, in the processing system:
a) determining additional information to be stored in a remote database, the additional information being at least partially indicative of the registration information;
b) storing the additional information in the remote database;
c) generating an information identifier indicative of the location of the additional information in the remote database; and,
d) generating the tag data in accordance with the information identifier.

Typically the method includes generating tag data including:
a) a payload, the payload including at least some of the registration information encrypted using a secret key; and,
b) a header, the header being indicative of the secret key.

Typically the tag data is at least partially encrypted, and wherein the method includes, providing secret keys to at least one entity authorized to read the tag data from the tag.

Typically the tag data is at least partially encrypted, and wherein at least one of generation and distribution of secret keys is controlled by a trusted entity, and wherein the method includes, in the processing system, obtaining the secret key from the trusted entity.

Typically the method includes, in the processing system, at least one of:
a) generating the secret key in accordance with a predetermined algorithm; and,
b) determining the secret key from a trusted third party.

Typically the method includes, in the processing system:
a) generating one or more markings at least partially indicative of the registration information; and,
b) causing the markings to be applied to the label, the markings being substantially invisible to the unaided eye, the markings being at least partially indicative of the registration information.

Typically the method includes, in the processing system, causing a tag reader to generate a write signal, the write signal being modulated in accordance with the tag data and the tag being responsive to the write signal to store the tag data in the tag data store.

Typically the processing system is at least one of:
a) part of the tag reader; and,
b) connected to the tag reader via a communications system.

Typically the processing system includes a printer for printing the printed information.

Typically the registration information includes at least one of:
a) details of an entity performing the registration;
b) registration limitations;
c) vehicle details;
d) vehicle owner details;
e) purchase information;
f) insurance information; and,
g) outstanding infringement notifications.

In a second broad form the present invention provides apparatus for providing a registration label for a vehicle, the apparatus including a processing system:
a) determining registration information, the registration information being at least partially indicative of an identity of the vehicle; and,
b) generating a label by:
   i) causing printed information to be provided on the label, the label including a tag having a tag data store, and the printed information being at least partially indicative of the registration information; and,
   ii) causing tag data to be stored in the tag data store, the tag data being at least partially indicative of the registration information, the label being provided to allow the label to be attached to the vehicle, thereby allowing at least some of the tag data to be retrieved from the label using a suitable reader.

Typically the apparatus includes a tag reader for generating a write signal, the write signal being modulated in accordance with the tag data and the tag being responsive to the write signal to store the tag data in the tag data store.

Typically the processing system is at least one of:
a) part of the tag reader; and,
b) coupled to the tag reader via a communications system.

Typically the apparatus includes:
a) an input for receiving an operator identifier indicative of an identity of the operator;
b) a modulator for generating a write signal; and,
c) a processor for:
   i) authenticating the operator using the operator identifier; and,
   ii) in response to a successful authentication:
      (1) determining registration information;
      (2) generating tag data using the registration information and a secret key;
      (3) causing the modulator to generate a write signal, the write signal being modulated in accordance with the tag data, the tag being responsive to the write signal to store the tag data in a tag data store.

Typically the apparatus performs the method of the first broad form of the invention.

In a third broad form the present invention provides a vehicle registration label including:
a) a substrate having at least one adhesive portion for allowing the substrate to be attached to a vehicle;
b) printed information provided on the label, the printed information being at least partially indicative of registration information; and,
c) a tag having a tag data store, the tag data store storing tag data at least partially indicative of the registration information.

Typically the label includes at least one security feature for detecting tampering.

Typically the label includes first and second adhesively connected substrate portions, such that when the substrate is attached to a vehicle, an attempt to remove the substrate from the vehicle causes separation of the first and second substrate portions.

Typically at least one of the first and second substrate portions includes a marked surface that is exposed when the first and second substrate portions are separated, the marking being indicative of attempted label removal.

Typically the tag is coupled to a tag antenna, and wherein:
a) the tag is coupled to the first substrate portion; and,
b) the antenna is coupled to the second substrate portion, such that separation of the first and second substrate portions disconnects the antenna from the tag.

Typically the tag is embedded within a material having predetermined optical properties, and wherein deformation of the label causes a change in the optical properties of the material to thereby indicate tampering with the label.

Typically the tag includes dye capsules embedded in the material, the dye capsules being adapted to release dye upon deformation of the label.

Typically the registration label includes one or more markings substantially invisible to the unaided eye, the markings being at least partially indicative of the registration information.

Typically the label is generated using the method of the first broad form of the invention.

In a fourth broad form the present invention provides a method of performing an action relating to a vehicle having a registration label including a tag having a tag data store, the method including, in a processing system:
a) determining tag data from the tag data store, the tag data being at least partially indicative of registration information; and,
b) determining at least one action; and,
c) performing, using at least some of the registration information, the at least one action.

Typically the tag data is formed by encrypting at least part of the registration information, and wherein the method includes, in the processing system:
a) determining a secret key; and,
b) using the secret key to at least partially decrypt the tag data.

Typically the method includes, in the processing system:
a) determining an operator identifier indicative of an identity of the operator;
b) authenticating the operator using the operator identifier; and,
c) in response to a successful authentication, performing at least one of:
   i) determining the tag data;
   ii) decrypting the tag data; and,
   iii) performing the at least one action.

Typically the method includes, in the tag reader:
a) receiving the operator identifier from the operator;
b) comparing the operator identifier to a number of predetermined operator identifiers stored in a database; and,
c) authenticating the operator in response to a successful comparison.

Typically the operator identifier includes at least one of:
a) a biometric signature;
b) a password; and,
c) a PIN.

Typically the method includes, in the processing system:
a) determining from the decoded information at least one information access level;
b) determining, using the operator identifier and from operator details stored in a database, one or more operator access levels;
c) comparing the information access levels to the operator access levels; and,
d) selectively displaying the information in accordance with the results of the comparison.

Typically the method includes, in the processing system:
a) determining an information identifier from the decoded information; and,
b) using the information identifier to access additional information stored in a remote database.

Typically the tag data includes:
a) a payload, the payload including the information encrypted using the secret key; and,
b) a header, the header being indicative of the secret key, and wherein method includes, in the processing system:
   i) determining, from the header, an indication of the secret key;
   ii) determining the secret key using the secret key indication; and,
   iii) decrypting the payload using the secret key.

Typically the method includes, in the processing system, at least one of:
a) generating the secret key in accordance with a predetermined algorithm; and,
b) determining the secret key from a trusted third party.

Typically the method includes, in the processing system:
a) determining at least one action associated with the registration information; and,
b) performing the at least one action at least in part in accordance with input commands from an operator.

Typically the method includes, in the processing system, causing a tag reader to:
a) generate a read signal, the tag being responsive to the read signal to modulate the read signal in accordance with tag data stored in a tag data store; and,
b) detect modulation of the read signal to thereby determine the tag data.

Typically the processing system is at least one of:
a) part of the tag reader; and,
b) coupled to the tag reader using a communications system.

Typically the method includes, in the processing system, causing markings on the label to be exposed using a source of non-visible radiation, the markings being responsive to the non-visible radiation to generate visible radiation and the markings being indicative of the registration information.

Typically the action includes at least one of:
a) issuing infringement notices;
b) identifying stolen property; and,
c) identifying a vehicle owner.

Typically the method is performed using at least one of:
a) a registration label according to the third broad form of the invention; and,
b) a registration label generated using the method of the first broad form of the invention.

In a fifth broad form the present invention provides apparatus for performing an action relating to a vehicle having a registration label including a tag having a tag data store, the apparatus including a processing system for:
a) determining tag data from the tag data store, the tag data being at least partially indicative of registration information; and,
b) determining at least one action; and,
c) performing, using at least some of the registration information, the at least one action.

Typically the apparatus includes a tag reader for:
a) generating a read signal, the tag being responsive to the read signal to modulate the read signal in accordance with tag data stored in a tag data store; and,
b) detecting modulation of the read signal to thereby determine the tag data.

Typically the processing system is at least one of:
a) part of the tag reader; and,
b) coupled to the tag reader via a communications system.

Typically the apparatus includes:
a) an input;
b) a modulator for generating a read signal; and,
c) a processor for:
   i) authenticating the operator using an operator identifier received via the input; and,
   ii) in response to a successful authentication:
      (1) causing the modulator to generate a read signal, the tag being responsive to the read signal to modulate the read signal in accordance with tag data stored in a tag data store;
      (2) determine, using modulation of the read signal, the tag data;
      (3) determining, using the tag data, a secret key;
      (4) decoding the tag data using the secret key.

Typically the apparatus performs the method of the fourth broad form of the invention.

### BRIEF DESCRIPTION OF THE DRAWINGS

An example of the present invention will now be described with reference to the accompanying drawings, in which:

FIG. 1 is a schematic diagram of an example of a data tag;

FIG. 2 is a schematic diagram of an example of a tag reader;

FIG. 3 is a schematic perspective view of an the tag reader of FIG. 2;

FIG. 4 is a schematic diagram of an example of a computer system;

FIG. 5 is a flow chart outlining an example of the process of interacting with a tag;

FIG. 6 is a flow chart of an example of the process of registering an operator with a tag reader;

FIGS. 7A and 7B are a flow chart of an example of the process of writing registration information to a tag;

FIG. 8 is a flow chart of an example of the process of reading registration information from a tag;

FIG. 9 is a first example of a registration label incorporating a tag;

FIG. 10 is an example of a vehicle having the label incorporating a tag;

FIG. 11 is a second example of a registration label incorporating a tag; and,

FIGS. 12A to 12D are examples of a registration label incorporating security features.

### DETAILED DESCRIPTION OF THE PREFERRED EMBODIMENTS

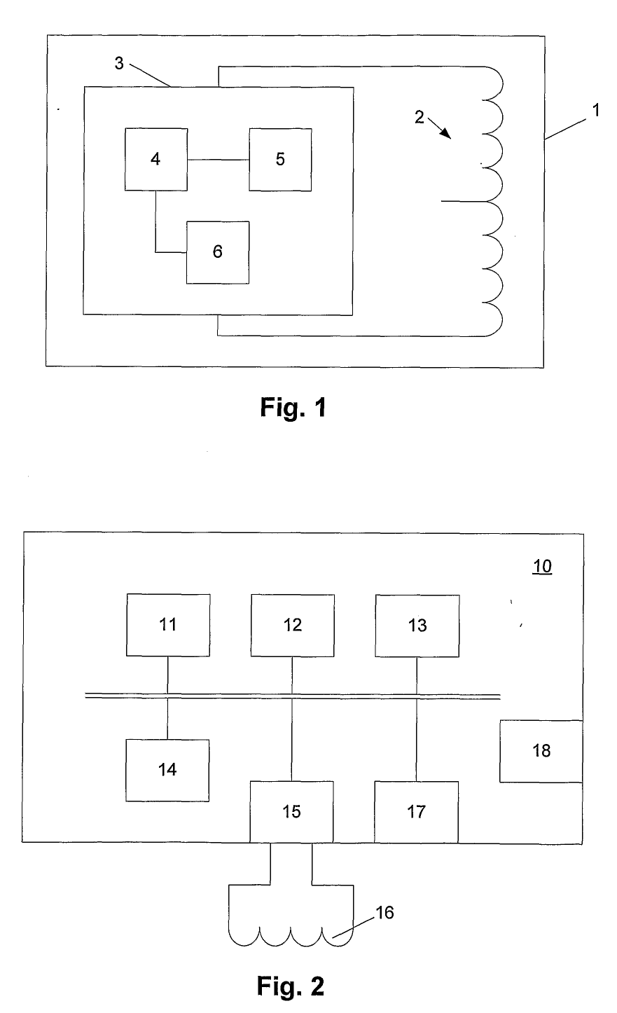

An example system will now be described with reference to FIGS. 1 to 4, which show a tag, an associated tag reader/writer (hereinafter referred to generically as a “tag reader”) and a computer system which may be used with the tag reader.

In particular, FIG. 1 is a schematic diagram of an example of a tag that may be coupled to a vehicle, such as an automobile, truck, car, boat, ship, train, or the like, as part of a registration label. In this example the tag 1 includes an antenna 2 coupled to a controller 3. The controller 3 is typically a microprocessor that provides desired data storage and output functionality. To achieve this, the controller 3 typically includes a processor 4, a memory 5 and a modulator 6 as shown.

In use, the tag is adapted to receive a signal via the antenna 2. The controller 3 operates to rectify the signal to thereby obtain power, which is supplied to the processor 4, allowing the processor 4 to interact with the memory 5 by writing data thereto, or reading data therefrom, as will be described in more detail below. This allows the tag to perform two-way communication with an associated tag reader, thereby allowing information stored on the tag to be retrieved and viewed.

The tag is used to store information related to a respective vehicle. This may be achieved either by storing a unique identifier that can be used to cross reference a remote database containing registration information relating to the vehicle, or can alternatively be used to store the registration information directly on the tag itself, depending on the preferred implementation. The registration can include for example at least one of:
Manufacturer information which may include:
   Vehicle Make;
   Vehicle Model;
   Year of Manufacture;
   Manufacturer identity;
   Country of Manufacture;
   Engine/Chassis number;
   Vehicle part numbers;
   Odometer reading;
   VIN (Vehicle Identification number);
   Transmission number;
   Steering rack number;
   Differential number;
Owner information which may include:
   Owner's name;
   Owner's address;
   Owner's license number;
Registration details;
Inspector details;
Servicing details;
Insurance details; and,
Contact details of main driver of the vehicle.

It will be appreciated that the registration information stored and retrieved on the tag will have various applications, as will be described in more detail below.

The tag typically forms part of a registration label, as will be described in more detail below, but may also be coupled to a vehicle directly using various methods. For example the tag may be attached directly the vehicle frame or chassis, or form part of a plate which is coupled to the engine or other suitable parts of the vehicle.

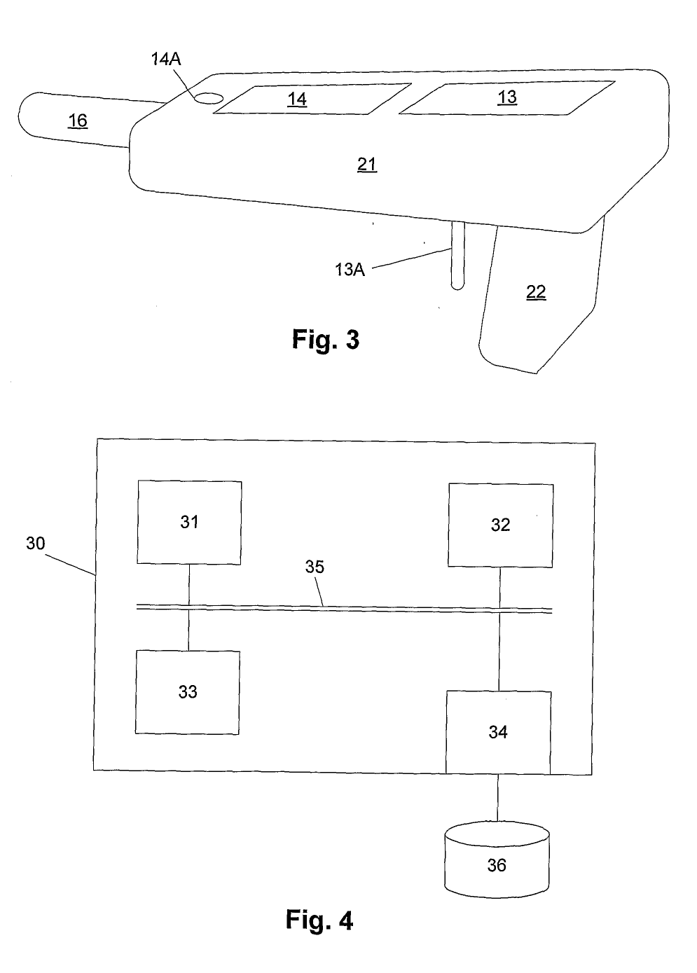

An example of a reader is shown in FIGS. 2 and 3. In particular, the reader 10 includes a processor 11 coupled to a memory 12, an input device 13, a display 14, a modulator 15 and an external interface 17 via a bus 18 as shown. The modulator 15 is coupled to an antenna 16.

In use, the modulators 6, 15, and the associated antennas 16, 2, when positioned in close proximity, form an inductively coupled tuned circuit. Accordingly, passing an alternating current through the antenna 16 causes a corresponding current to be induced in the antenna 2. The modulators 6, 15 can be used to alter the inductance, and hence the resonant frequency of the tuned circuit, which in turn allows information to be transferred between the tag 1 and the reader 10.

Thus, generation of a suitably modulated signal by the modulator 15 can be detected by the modulator 6, allowing data to be written to the tag 1. In this case, the processor 4 interprets the modulated signal, and writes the received data into the memory. Conversely, the modulator 6 can be used to modulate the signal induced in the antenna 6. This in turn causes backscatter modulation of the signal generated by the modulator 15, which can be detected by the modulator 15, allowing data to be read from the tag.

It will be appreciated by persons skilled in the art that in one example this is therefore an RFID type tag system. In this case, modulation of the signals can be either phase or amplitude modulation, with the coupling between the tag and the reader being either inductive (as described above) or capacitive, depending on the preferred implementation.

An example of the external configuration of a portable reader 10 is shown in FIG. 3. As shown, the reader 10 includes a housing 20 having a main portion 21 coupled to a handle 22. The housing typically includes the display 14, optional additional display indicators 14A, and the input device 13, typically in the form of a keypad entry system 13, or the like, mounted thereon. Additional input control such as trigger 13A may also be used as shown.

In one example, the antenna 16 is in the form of a telescopic antenna as shown in FIG. 3. Alternatively the antenna may be contained provided within the main housing 21 depending on the intended use, as will be described in more detail below.

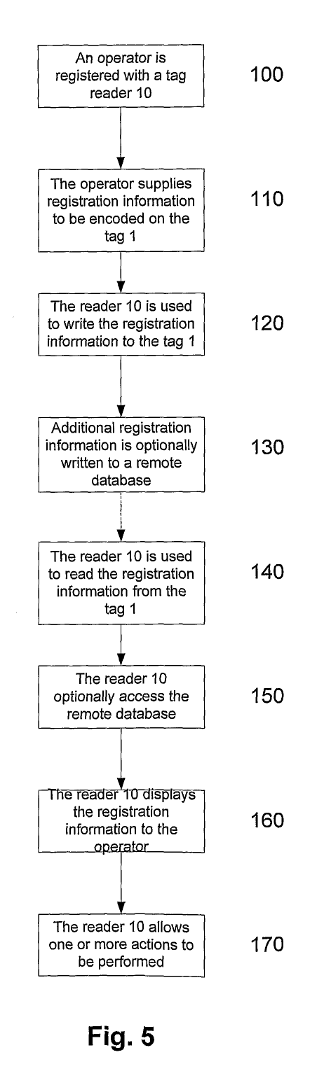

Typically the reader 10 is also adapted to communicate via the external interface 17 with a computer system, shown generally at 30 in FIG. 4. Typically the computer system includes a microprocessor 31 coupled to a memory 32, an input/output device 33, such a keyboard and display or the like, and an external interface 34, coupled together via a bus 35 as shown. The computer system 30 may be coupled to a remote database 36, via the external interface 34, as shown.

Additionally, or alternatively, the external interface 34 may be coupled to the external interface 17 of the reader 10, such as through the use of an RS232 serial connection, USB connection, wireless Bluetooth connection, or the like. In use the processors 11, 31 execute application software that allows the reader 10 and the computer system 30 to communicate and transfer data therebetween as required. Additional functionality may also be provided as will be described in more detail below.

It will therefore be appreciated that the computer system 30 may be any form of a computer system such as a desktop computer, lap-top, palm-top, specialized hardware or the like. Similarly, the processor 11 utilized by the reader 10 can be implemented in a variety of forms and may be formed from a Programmable Logic Array (PLA), specialized hardware or the like.

In use, the system allows registration information to be stored on, and subsequently retrieved from the tag 1 using the reader 10 alone, or using a combination of the reader 10 and the computer system 30. In a preferred example of the invention, the tag 1 is a tag having a high data storage capacity, such as a 125kHz Hitag S 2048 RFID tag. This allows a significant amount information, and in particular, up to 1920 bits or 240 characters, to be stored directly on the tag, without necessarily requiring access to a remote database.

In such a system, as tags may be read remotely and using any appropriate reader, there is the potential for any information stored on the tag to be accessed by third parties. As in many applications to the tag will contain confidential information such as user details, this is undesirable. Accordingly, in order to ensure that privacy of the information is maintained, the system utilizes a strong encryption technique so that the information is stored on the tag 1 in an encrypted format. This, coupled with controlled dissemination of the secret keys, ensures the information remains secure.

An example of use of the system will now be described with reference to FIG. 5.

In particular, at step 100 an operator, such as an employee with a vehicle registering authority, undergoes a registration procedure, which associates the operator with one or more respective tag readers 10. This creates a unique association between the operator and the reader(s) 10, so that only validly registered operators may use the readers 10. This may be a one off procedure, and is not required each time information is to be written to a tag.

At step 110 registration information to be encoded within the tag 1 is provided to the reader 10, either via the computer system 30 or via the input device 13. The registration information is information associated with a respective vehicle and provided for registering the vehicle with an appropriate registration authority. This may therefore include a range of information relating to both the vehicle and the vehicle owner, as outlined above.

At step 120 the registration information, or at least a part thereof, is written to the tag 1 in an encrypted form. Further information may also be optionally written to the remote database 36 if required at step 130.

These steps, which represent the writing procedure, are typically performed by the registration authority and involve writing the information to a tag provided on an authorized registration label, which is typically also printed with relevant information as will be described in more detail below. Once this procedure is complete, the label can be provided to the vehicle owner and attached to the vehicle in the normal way.

The process for subsequently reading information from the tag 1 is shown in steps 140 onwards. In particular, at step 140 a reader 10 reads the encoded information from the tag 1, with optional additional access to the remote database 36 being performed at step 150 if required. This allows the reader 10 to gather the information associated with the tag 1, which may then be displayed to the operator on the display 14 at step 160. One or more actions associated with the provided information may then be performed at step 170.

It will be appreciated that the process may be performed other entirely by the reader 10, or partly by the reader 10 in conjunction with the computer system 30. Thus, for example, information to be written to the tag may be input into the computer system 30 and then subsequently uploaded to the reader 10. This may be used if the computer system 30 has a more user friendly input interface that allows for easier entry of the data. For clarity the following description will focus on the process being performed by the reader 10, although it will be appreciated that all of the processes may be performed by the reader 10 in conjunction with the computer system 30, depending on the preferred implementation.

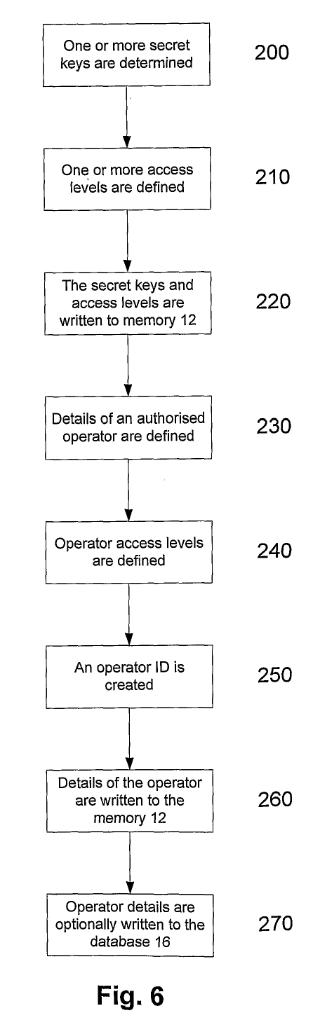

The process will now be described in more detail with respect to FIGS. 6, 7 and 8.

In particular, the procedure for registering an operator to use the reader is set out in FIG. 6. In this example, the process is generally separated into a reader initialization phase at steps 200 to 220, and an operator registration at steps 230 to 270.

During the reader initialization phase, as shown at step 200, one or more secret keys are generated. The secret keys are keys that are to be used for encrypting specific types of information, as will be described in more detail below, and therefore an indication of the associated type of information may also be provided.

It will be appreciated that the secret keys can be shared amongst a number of readers to allow a number or readers to access the data provided on a tag 1, in which case the keys may be obtained from a database or the like. Alternatively, the secret key may be new, for example if it is unique to respective reader 10, or if it is the first time a respective type of information is to be used, in which case the ley may be generated using a predetermined algorithm. Whilst any form of secret key encryption system may be used, in one example the system uses a 128 bit AES encryption protocol and based on a 64 bit secret key.

At step 210 it is possible to define one or more access levels. These represent an access right associated with information that is to be provided to the tags, thereby allowing access to information to be selectively restricted so that different operators may be assigned different access rights.

At step 220 the one or more keys and details of the one or more access levels are stored in the memory 12 of the reader 10 using conventional techniques.

It will be appreciated that steps 200 and 220 may only need to be defined the first time the reader 10 is used. Alternatively, depending on the respective circumstances these may be repeated as often as required.

At step 230 it is necessary to define operator details associated with one or more operators of the reader 10. The operator details may include a range of information such as the operator's name and other personal information, details of employment, employers, or the like. Once basic details regarding the operator are provided, access levels associated with the operator are defined at step 240. Thus, it will be appreciated that if a number of operators are associated with the reader 10 is may be desirable that some information stored on the tag 1 is only viewable by certain operators, in which case those operators may be provided with a different access level. Access levels may also be used to control writing of information to tags 1.

At step 250 an operator ID is created to allow the operator to be authenticated by the reader 10. The nature of the ID will depend on the authentication mechanism used and will be discussed in more detail below. At step 260, details of the operator including at least the operator ID and any access levels associated with the operator are stored in the memory 12 of the reader 10. Further details may also be stored in the remote database 36 to allow these to be accessed or updated independently of the reader 10.

Following this procedure, the operator is then able to use the respective reader 10 for tag reading/writing operations.

As an alternative to the procedure described above, the operator details may be stored solely in the database 36, in which case when authentication of the operator is performed, then this requires the reader 10 to access the remote database 36.

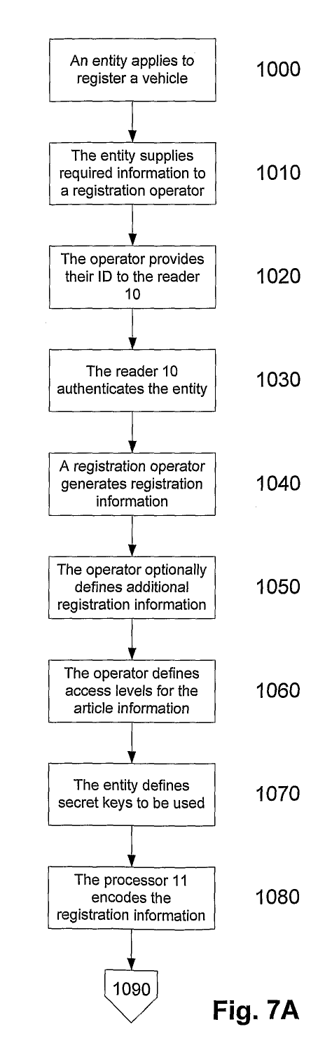

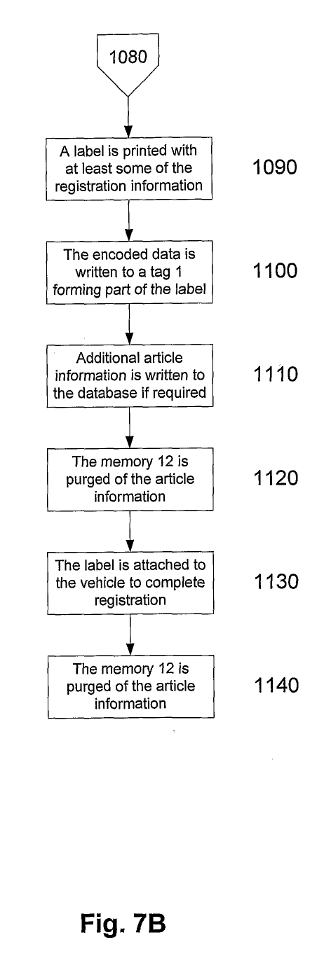

In any event, an example of use of the reader 10 to write information to the tag 1 will now be described with reference to FIGS. 7A and 7B.

The creation of registration labels is typically performed at a registration authority, and accordingly at step 1000, an entity, such as the vehicle owner, applies to a register a vehicle and supplies required information to an operator at the registration authority at step 1010. It will be appreciated that the information that must be supplied will depend on the particular registration scenario.

Thus, for example, if the owner is arranging for transfer of a vehicle from a previous owner, then this will typically require that new owner details are provided, as well as any information required to satisfy transfer requirements. In the event that a registration is being renewed however it may simply be permissible to provide an indication of the car registration, confirmation of the entity identity and a suitable transaction fee. Typically evidence of road worthiness, presence of insurance and the like may also need to be provided, together with any information that may be required depending on legislative requirements in the relevant jurisdiction. This may also include any of the information discussed below with respect to step 1040.

In any event, at step 1020 the operator typically provides their ID to a reader 10, to allow the reader to authenticate the operator at step 1030. The manner in which this occurs will depend on the implementation. Thus, for example, the reader used at the registration authority may be connected to an internal computer system, such as a LAN, or the like. In this case, when the operator logs onto the registration authority's computer system, this can be used to automatically authenticate the operator with the reader 10. Alternatively, the operators computer may be required to forward authentication credentials to the reader when a label is to be created.

At step 1040 the registration operator generates registration information. The registration information will again depend on the jurisdiction in which the vehicle is being registered and local legal requirements. Typically however the registration information will include one or more of:

registration information such as:
manufacturer's identity;
vehicle make/model;
year/date of manufacture;
year/date of first registration;
engine capacity;
vehicle colour;
manufacture location;
vehicle type (eg 2 door saloon);
odometer reading;
VIN (Vehicle Identification Number);
chassis number;
engine number;
year of build;
transmission number;
steering rack number;
differential number; and,
any other related information.

purchase information such as:
date of purchase;
owner information;
an authority or sale from the previous owner;
transaction details, such as price or the like;

clearance information confirming the vehicle has satisfied road worthiness requirements such as:
clearance number;
inspection date;
inspection number;
clearance restrictions;
details of entity performing inspection;
mechanic identity;
modification date;
modification reference number;
a list of modifications made; and,

registration details such as:
the registration number;
license plate number;
the registration expiry date;
manufacturer's identity;
vehicle make/model;
year/date of manufacture;
year/date of first registration;
engine capacity;
vehicle colour;
manufacture location;
vehicle type (eg 2 door saloon);
odometer reading;
VIN (Vehicle Identification Number);
chassis number;
engine number;
year of build;
transmission number;
steering rack number;
differential number; and,
car colour;
odometer reading;
a valuation;
dealer identity;
vehicle source;

details relevant to the owner/driver such as:
insurance company details including:
   policy numbers;
   insurance provider identity;
   expiry date;
finance company details including:
   policy numbers;
   finance company identity;
   expiry date;
owner details including:
   name;
   address;
   next of kin;
   intended or normal parking location;
   details of the main driver;
   details of any other designated drivers; and,
outstanding infringement notifications such as:
   outstanding parking tickets;
   outstanding road tolls; and,
   outstanding traffic offenses; and,

any other related information.

Thus, in addition to simply defining information relating to the vehicle and the owner, the information encoded on the tag could include information relating to outstanding fines or the like. In order to achieve this, the relevant fine issuing authority will notify the registration authority of any outstanding fines on a periodic basis. This information can then be written to the registration label when it is replaced on an annual basis, thereby allowing the information to be retrieved by an appropriate inspector to allow decisions regarding action to be performed on an informed basis as will be described in more detail below.

At step 1050 the operator optionally defines additional registration information. This includes information which needs to be recorded but which is not suitable for recordal on the tag 1 for some purpose. Thus, this may include for example internal reference numbers relating to the registration authority or the like. In addition to this, it will be appreciated that registration information written to the tag may also be duplicated in a second database and therefore included within the registration information referred to above.

During the process of determining the registration information the operator may obtain data from a number of sources.

Thus, typically a car will include existing registration information unless it is an entirely new registration. In the event that existing registration information exists, this is therefore used as a basis from the new registration information with information being altered or additional information being obtained as required. The additional information may be obtained from a number of sources, such as from the entity (i.e. at step 1010), from a registration database, or the like.

Alternatively, or additionally, the information may be entered via the input 13 or alternatively via the computer system 30, which then transfers the registration information to the reader 10 via the external interface 17.

At step 1060 the operator defines access levels for the registration information. A single access level may be defined for all of the information, or alternatively, different portions of the information may be associated with different access levels, depending on the information's sensitivity.

For example, the registration information may include manufacturer information and/or owner information as discussed in above. In certain situations, it may be appropriate that a particular operator may only be able to read the manufacturer information, whilst another operator which may be able to read and write both owner and manufacturer information. Various levels of authorization such as access flags may be used to indicate the access of data for particular operators, as will be described in more detail below.

Thus, the access levels may vary for different portions of the information and it will therefore be appreciated that this can be achieved by defining different classes of registration information with a different access level being defined for each respective class

In order to ease entry of the information, it is typical for the user to be presented with a GUI (graphical user interface), on the computer 30, which includes fields into which the information may be entered. The respective fields presented may depend on the type of information provided. In any event, this can allow the user to associate different access levels with the different fields, thereby easily designating the access levels.

At step 1070 secret keys used in encrypting the registration information are defined. This may be selected automatically by applications software executed by the processor 11, for example depending on the type of information entered, or may alternatively be selected by the operator, for example, from a key database, or generated in-situ utilizing an appropriate algorithm. Multiple keys may also be assigned for example to encode information having multiple different access levels.

At step 1080 the process 11 encodes the registration information using the one or more secret keys. This is typically achieved by having the processor 11 operate to generate a binary string representing the registration information to be stored on the tag, together with details of the associated access levels. This will typically be achieved by encoding the registration information as a character string, using associated flags to define the access level.

The resulting string is then encrypted using the selected secret key, to generate an encrypted string. The encrypted string is then associated with a header indicative of the secret keys to encrypt data. The encrypted string will hereinafter be referred to as a payload, with the combined payload and header forming a data packet.

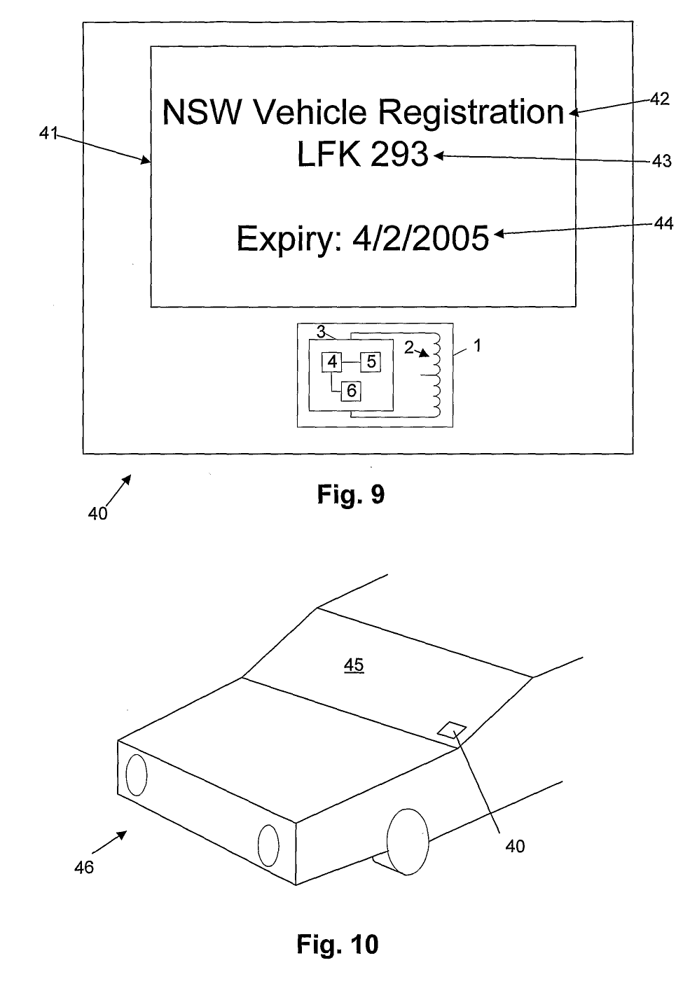

At step 1090 a registration label is then printed with at least some of the registration information. An example registration label will now be described in more detail with reference to FIGS. 9 and 10.

In particular, as shown in FIG. 9 the registration label 40 would include a tag 1, together with printed registration information 41. The printed registration information would typically correspond to standard car or other vehicle registration information depending on the jurisdiction involved. Thus, in the example shown the information includes an indication of the authority issuing the registration at 42, a vehicle registration number 43, and an expiry date 44.

In the use the registration label 40 can be fitted to the windshield 45 of a vehicle 46 as shown. Thus, this allows the registration label to be used in the normal way. However, in addition to providing standard registration information additional information can be stored in the tag as will now be described.

Thus the registration label 40 typically includes at least minimal registration information including the registration number and an expiry date of the registration, etc, and this may be identical to the information included on existing registration labels issued by the registration authority.

At step 1100, after the registration label is printed, the reader 10 will operate to write the encoded registration information to the tag. This is achieved by having the processor 11 control the modulator 15, causing the modulator to generate a write signal modulated in accordance with the encoded data. It will be appreciated that write the signal generated by the modulator 15 will inductively couple power to the controller 3, with the modulation being detected by the modulator 6. The processor 4 interprets the modulation to determine the data packet and writes this to the memory 5.

This process is generally performed as a WORM (write once, read many) process, so that the data cannot be subsequently altered, although this is not essential. This may be achieved in a number of ways, such as by setting a flag in the header of the data packet indicating that the data cannot be overwritten.

It will be appreciated by persons skilled in the art that although the tag is locked, this does not prevent the tag being be provided with spare data capacity to allow additional information to be written onto the tag at a later date. This can include for example indications of changing ownership or the like. In addition to this, the process can be used to identify vehicles which have been repeatedly subject to infringement notification or the like.

At step 1110 additional registration information can also be written to the remote database if required. If this is performed, a unique identifier is stored as part of the data packet, and as part of the information stored in the database 26, thereby allowing the registration information stored in the database 36 to be subsequently associated with the respective tag 1. An example of such additional registration information may include distinctive physical indica of the vehicle, such as the inclusion of an airfoil, sunroof, or floodlights.

At step 1120 the contents of the memory 12 in the reader 10 and additionally the contents of the memory 32 and the computer system 30 are purged to thereby ensure the registration information is not retained on the device. This helps further ensure the confidentiality of the information.

At step 1130 the user attaches the label to the vehicle to complete registration.

It will be appreciated that this process is repeated on a periodic basis, such as annually, to thereby ensure that the details on the label are kept up to date. Thus, as in normal registration procedures, the registration is typically only valid for a year. At the end of this period, the user will remove and dispose of the label, arranging for a new label, with updated details, to be issued by the registration authority.

Thus, in one example, the above describes a process which allows registration authorities to issue registration from centralized or regional, or local centres, in the normal way, but to additionally include registration information embedded electronically within the label. This allows additional information to be stored within the label, whilst allowing this information to be made available only to selected parties through appropriate access protocols.

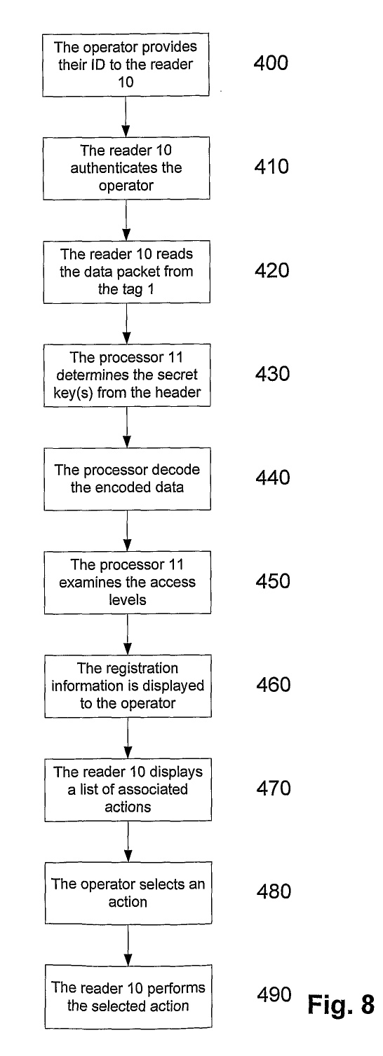

The manner in which information is read from the tag will now be described with reference to FIG. 8.

In particular at step 400 the operator supplies their ID to the reader 10, thereby allowing the reader 10 to authenticate the operator at step 410.

At step 420 the operator activates the reader 10, for example using the trigger 13A, and then places the reader 10 adjacent the tag 1, thereby causing the reader 10 to read the data packet from the tag 1. This typically requires the processor 11 to cause the modulator 15 to generate a read signal, which is an alternating signal with no modulation. The read signal inductively couples power to the tag 1 thereby powering the controller 3. This in turn causes the processor 4 to access the data packet stored in the memory 5, and then cause the modulator 6 to modulate the resonant frequency of the tuned circuit. This in turn alters the phase or amplitude response of the tuned circuit, which is detected by the modulator 15, thereby allowing the processor 11 to determine the data packet.

The processor 11 then operates to read the data packet header at step 430, and determine the one or more secret keys used in encrypting the payload, thereby allowing the processor 11 to decrypt the payload using the secret keys at step 440.

The processor 11 then operates to parse the decrypted data to determine any access levels associated with the registration information provided therein, at step 450. This allows the processor 11 to compare the access level of the operator with the access level of the registration information and assess whether the operator is authorized to view some, or all, of the registration information. This registration information is then presented to the operator at step 460, using the display 14. Alternatively, or additionally, the information may be displayed on the computer system 30.

At this point, if information is stored in the remote database 36, the processor 11 will determine this due to the presence of the unique identifier. In this case, the reader 10 will access the database 36 if possible, for example via a wireless network, such as the mobile phone, GPRS network, or the like, and display the additional information to the operator. Alternatively, if the database 36 cannot be accessed, then this may be indicated to the operator on the display 14, allowing the registration information to be retrieved at a later opportunity.

In addition to displaying the registration information, the reader 10 may be adapted to allow one or more actions to be taken relating to the registration information. Whilst this does not generally include alteration of the registration information stored on the tag 1, this could include using the registration information for certain purposes, as will be described in more detail below.

In this case, the processor 11 will determine a list of actions associated with the registration information or other available actions depending on the implementation and display these to the operator at step 470. This is typically achieved by having the processor 11 execute applications software, which is stored in the memory 12, and which is specific to the respective use of the reader 10, as will be appreciated by a person skilled in the art.

At step 480 the operator provides appropriate input, thereby allowing the reader 10 to perform respective actions at step 490, in accordance with instructions defined in the applications software.

This can be used for example to identify the vehicle, for example in the event that the vehicle is stolen, or required for a recall, or the like. It can also be used to provide vehicle tracking for example, for use in issuing infringement notifications relating to speeding, parking tickets, or the like, as well as to allow for collection of road tolls.

To achieve this, the information written to the tag 1 may include details to identify the owner. Accordingly, it will be appreciated by a person skilled in the art that as it will be desired to ensure that the owner information remains confidential and is only available to relevant authorities, the issuance of secret keys capable of decrypting the information stored on the asset registration tags is strictly controlled and limited to certain pre-authorized operators.

Entities which may be provided with authority to write and read information can include but is not limited to statutory authorities, Police, Law Enforcement Agencies, Finance Companies, Insurance Companies, Logistic Operators, Stock Controllers etc., depending on the circumstances in which the system is used.

Thus, for example, if the registration label is used in issuing infringement notifications, such as speeding tickets, parking fines or the like, the vehicle and owner details can be accurately determined by a relevant authority, such as a parking inspector, using a reader 10. The reader 10 can then execute applications software that allows infringement notices to be issued, for example, once the Policemen or Traffic Attendant has read the information from the tag, the owner's details are displayed.

Thus, the reader operator can be presented with a list of potential options such as issuing a speeding ticket, issuing a parking fine or the like, depending on the use of the reader 10. The operator will then select an appropriate option and this will cause the ticket to be issued.

This may be achieved in a number of ways. For example, the reader 10 can communicate with the remote computer system 30 transferring the car owner's detail to the computer system allowing the infringement notification to be issued by the computer system 30. This may be achieved for example by printing a notification and posting this in the normal way. Alternatively the reader 10 can be coupled to a printer via the external interface 17.

It will be appreciated that the techniques can also be used to collect road tolls in a similar manner.

A further use of the tag is that the tag can be used to store information regarding unpaid infringements, or details of past traffic infringements. Thus, for example, if a driver is prosecuted related to a traffic offense, this information could be supplied to the traffic authority so that when a registration label is next created for the vehicle which the driver owns, details of the offense can be included on the registration label. As a result, if the vehicle is involved in a traffic incident, the police can access the information stored on the tag and use this to assess if the driver has previous traffic violations, and take appropriate actions. This avoids the need for the police to check with a centralized system.

Similarly, the tag could be used to encode details of unpaid parking fines or the like. In this instance, if a parking inspector inspects the vehicle, for example during normal parking monitoring procedures, and determines that outstanding fines are in place, this will alert the inspector that action needs to be taken. In this case, the action could include, for example arranging for the vehicle to be towed or clamped until the outstanding fines are paid. In this case, as fines may have been paid after the registration label is issued, the inspector would generally check with a centralized and up to date database to see if action is required. This does however alert the inspector to the fact that further investigations are required.

This allows police to compare these details to those of the current driver, which can assist in recovering stolen vehicles, or the like.

The above described system allows car registration procedures to be implemented by embedding a tag 1 in a registration label.

To achieve this, the general process involves having a registration entity determine registration information, and create a registration label in the normal way. However, instead of only providing registration information on the label in the form of printed visible information, the entity also operates to encode some of the registration information on a tag 1 incorporated as part of the label.

The information is typically locked to prevent its subsequent alteration, before being provided to the vehicle owner to allow the label to be attached to the vehicle in the normal way. In this instance, when a third party requires the vehicle registration to be checked, this can be achieved either by visual examination of the label to review the printed information in the normal way. However, additionally, or alternatively, the registration information encoded within the tag 1 can also be read using a suitable reading process, as outlined above, thereby allowing additional checking of the registration to be performed.

Whilst the above described process has been described with respect to usage of the tag 1 and reader 10, and the associated methodologies described above in FIGS. 1 to 10, the system may utilize any suitable tag and reader, and this is for the purpose of example only.

Further Features

Some additional features/functionality of the system will now be described in more detail below.

Tag Reading

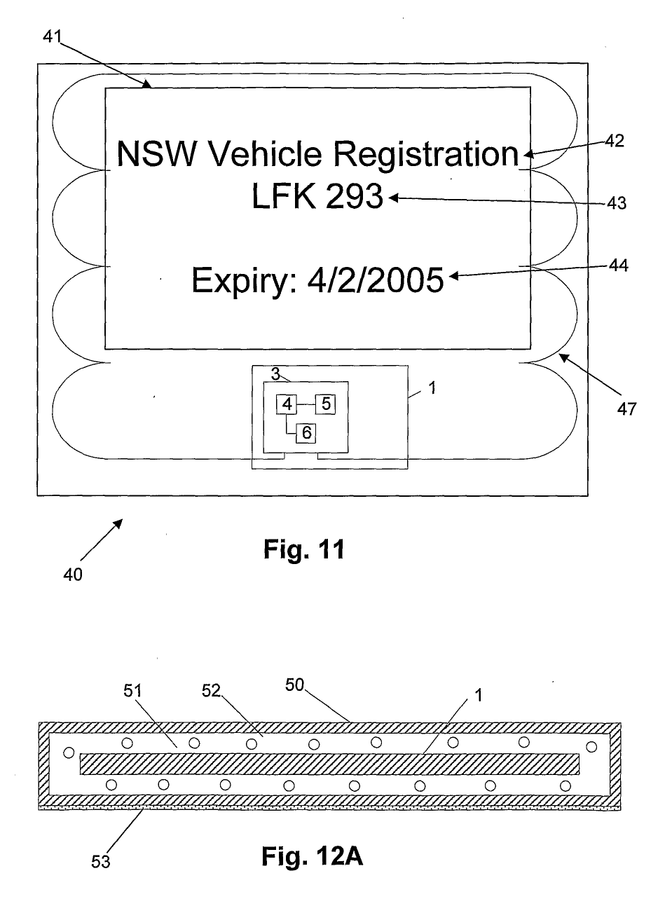

It will be appreciated by a person skilled in the art that if a registration label is positioned on the inside of the car windscreen in the normal manner the presence of glass can reduce the effectiveness of read operations from the tag. In particular, it can be difficult for a reader 10 to successfully communicate with the tag 1 through the windscreen. In order to counteract the effects of this, the label can be modified as shown in FIG. 11 to include an expanded antenna 47. The use of an expanded antenna disposed over a large portion of the label increases the effectiveness of communication between the reader 10 and the tag 1 thereby reducing the interference effects caused by the windscreen.

A further issue with registration labels is that it may be desirable that the tag is only readable once the registration label has been fitted to vehicle. In order to achieve this, the label can be provided with a removable sticker portion which when removed provides the label with an adhesive surface to allow the label to be attached to the windscreen. In this instance by incorporating metallic material into the label part this can interfere with read processes effectively preventing the tag being read unless it has been attached to the vehicle. In this instance, a special reader is used to encode information on the tag.

Tag Encoding

It will also be appreciated by persons skilled in the art that as the tag is normally encoded in an office environment it is not generally necessary to encode the tag utilizing a handheld reader and desktop readers can be used.

In this instance, this allows specially configured readers to be used to provide modified data writing techniques. In particular, as the tag is provided in a label which is replaced on an annual basis, it is feasible to utilize a WORM (write once read many) tag by disabling the ability of the processor 11 or the modulator 15 to write information to the tag data store. It will be appreciated from this, that in one example, the modulator provided within the tag may not be provided with the ability to write data to the tag, with a modified reader 10 being used to provide the functionality of the modulator for writing purposes.

Furthermore, the use of a reading device with additional power can be utilized to successfully encode information even through a metallic portion of the label as discussed above.

UV Marking

In order to assist with the identification of tags encoded and readable using the above described techniques, it is useful to provide UV fluorescent trace indicators on items which have an associated tag.

The purpose behind this is it can be difficult to locate tags by simply positioning the reader 10 in close proximity to an item. In particular, reading of tags 1 can be effected by intervening materials positioned between the antennas 2, 16, such as metals or the like, which may effect the inductive properties of the tuned circuit. Thus, failure to read information may be cause either by the absence of a tag or by an invalid read.

Accordingly, items that are provided with a tag, such as the registration label, are typically marked with UV fluorescent ink, or the like. The readers 10 can then include an optional black light source that causes the UV markings to fluoresce thereby allowing objects having a tag to be identified.

Anti-Tamper Security

In order to provide additional security, the registration label may be provided with one or more security features. Such security features may include the presence of holograms or the like, which hamper reproducibility of the label. However, in addition to this, it is typical to provide some form of anti-tamper mechanism that is capable of indicating whether attempts have been made to physical tamper with either the registration label 40 or the RFID tag 1.

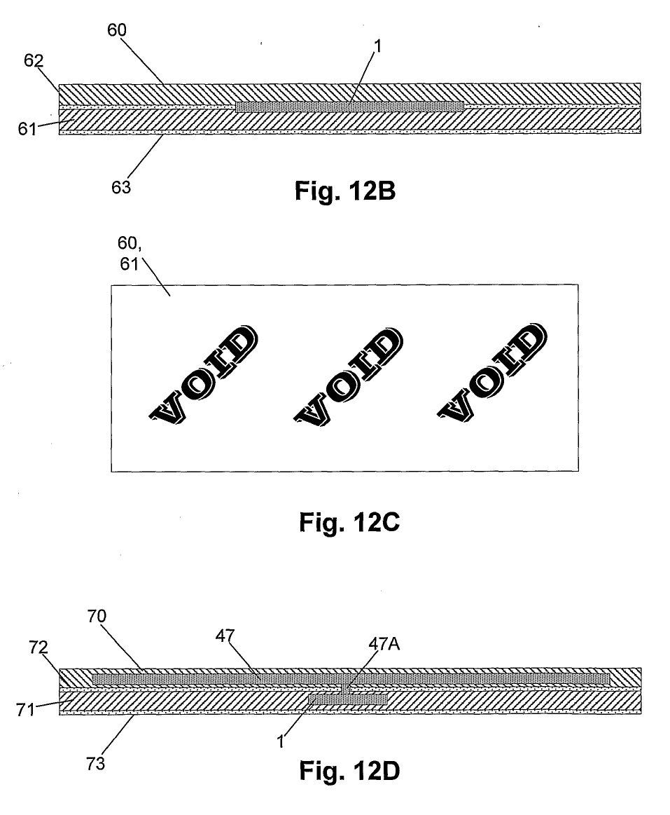

A first example will now be described with reference to FIG. 12A. In particular, in this example the security tag 1 is provided in housing 50 containing a transparent substance 51, such as a liquid polymer, or a transparent plastic, such as perspex, or the like. The transparent substance 51 includes a number of capsules 52 provided therein, with the capsules including liquid dye or the like. In this instance, when any attempt is made to access the housing 50, deformation of the housing 50 causes pressure to be distributed through the transparent substance 51 thereby fracturing one or more of the capsules 52. This in turn causes the release of dye into the substantially transparent material 51, thereby indicating that an attempt has been made to tamper with the tag 1.

It will be appreciated that by providing an adhesive layer on the underside of the housing, as shown at 53, or by providing the housing 50 as integrated part of a label 40, any attempt to manipulate the housing 50, or remove the housing 50 from the windscreen of the car will result in fracturing of the capsules 52 and hence indicate a tamper event.

It will be appreciated as an alternative to using capsules, the material 51 could be inherently adapted to undergo a colour change, for example in response to physical stress, or upon contact with air. Thus, fracturing or stress of the housing can result in a colour change of the material.

Furthermore, whilst the material is described as transparent in the above example, this is not essential and any visible change in the optical properties is sufficient to allow tampering to be identified. Similarly, in the event that the material 51 is solid, then the additional housing 50 may not be required.

An alternative arrangement is shown in FIG. 12B. In this example the registration label includes first and second substrate layers 60, 61 which are held all together by an adhesive 62. An adhesive layer 63 is provided to allow the label to be attached to the car windscreen in use.

In this example, the surface 1 of the substrates 60, 61 is imprinted with the wording void as shown in FIG. 12C. The wording is placed on a surface of one of the substrates 60 that faces the adhesive layer 62.

In use the label is produced so that the adhesive layer 63 is stronger that the adhesive layer 62. As a result, in the event that an individual attempts to remove the security label from the car windscreen the layers 61, 60 will separate such that one of the surface showing the wording of void is displayed, thereby indicating that tampering with the label has occurred.

A further example is shown in FIG. 12D. In this example the label is again formed from two substrate layers 70, 71. In this example the layer 70 includes the antenna 47 embedded therein and the layer 71 includes the RFID tag embedded therein. The tag 1 is connected to the antenna 47 via suitable connections 47A. The substrates 70, 71 are again interconnected via an adhesive layer 72 which is weaker than an adhesive layer 73 used to attach the label to the windscreen.

In this instance if an attempt is made to remove the tag from the windscreen, the layers 70, 71 will separate, thereby separating the antenna 47 and the remainder of the RFID tag 1 preventing correct operation.

In another example, the tag 1 may be associated with a device that deletes or modifies the contents of the tag memory 5 when the tag 1 is moved, or an attempt is made to tamper with the label. This can be achieved by placing the device in the layer 70, with the tag 1 and antenna 47 provided in the layer 71. In this example, the device can generate a magnetic field so that as the layers 70, 71 are separated, the field induces a current in the antenna 47, thereby allowing the tag 1 to detect that tampering has occurred, and consequently modify the contents of the memory 5. Alternatively, the device can be active and use a power source, allowing a signal to be generated, to thereby modify or delete tag memory 5 upon tampering with the label.

As a result, when the tag 1 is read by a reader 10, the reader can detect that the memory 5 has been deleted or altered, ad generate an appropriate message for display to the user, such as TAG VOID, or the like.

This allows the label to be used in any application where it is desirable to detect whether there has been unauthorized movement or attempted movement of the tag or the label from an intended position.

Secondary Database

As described above, the system includes the ability to write information to and read information from a secondary remote database, such as the database 36. It will be appreciated that this may be achieved in a number of manners.

For example, interaction with the database may be achieved solely through the use of the computer system, or alternative by providing appropriate communications within the reader 10. Depending on the implementation, this may use a database connected to a communications network, such as the Internet, or a private LAN or the like.

In this case, the reader advantageously uses a unique identifier encoded within the information stored on the tag 1 to uniquely identify the database record corresponding to the respective tag. This identifier might simply be a numeric reference to a particular database entry, or alternatively may be indicative of additional information, such as the respective database used. Thus, for example, the identifier could include a network address at which the database is provided, or alternatively may direct the reader 10 to a suitable LUT (look-up table) which provides details of the database.

Antenna

In general the antenna 16 will be provided within the housing 21. This is feasible because the housing is formed from plastic which has a negligible effect on the properties of the tuned circuit, and can be easily accounted for the circuit configuration.

However, in some circumstances the RFID tags may be provided in a location which is difficult to read utilizing such an antenna. For example when the RFID tags are incorporated into bikes it is typical to place the RFID tag within the bike frame. As the reader 10 is unable to communicate with the tag through the metal bike frame, it is therefore difficult to read the tag information correctly. Accordingly, the antenna may be in the form of a telescopic antenna which can be inserted into the frame of the bike. This ensures optimal inductive coupling between the antenna 16 and the antenna 2 thereby ensuring reading occurs correctly.

Communications

Communication with the computer system may be achieved using a number of different techniques, including wired connections, such as an RS232 connection, a USB connection, or the like. Thus, in one example, 10 pin RJ 45 connector is provided on the bottom of the handle 22 to allow full duplex communication between the reader 10 and the computer system 30. However, alternatively, or additionally, wireless connections, such as Bluetooth or Zigbee can be used.

Furthermore, the reader 10 may be provided with GPRS functions and capabilities to allow wireless connectivity to the Internet or other communications networks.

Display

The reader 10 includes a display such as a 112×64 pixel monochrome or colour graphics display which can be scrolled by pressing an associated input button. In this case, the display will provide general status information, as well as feedback during entry of information, authentication, and during the read process.

For example, if the trigger 13A is actuated then a message “READING TAG” will appear on the display until the tag is read, whereupon the information stored on the tag 1 will appear. An input button can be used to scroll through or otherwise review the information. In the event that no tag 1 can be detected, a “NO TAG FOUND” message can be displayed until the trigger is actuated again and the read cycle is repeated.

Printer

A built in printer function or transmission capability of information to a printer from a serial port is typically implemented by the processor 11, allowing information from tags, or other information, to be printed. Alternatively, or additionally, a printer may be incorporated into the housing 20.

Additional Visual & Aural Feedback

A speaker and/or additional visual indicators, such as an LED 14A may be used to provide additional feedback to an operator. For example, an audible sound can be generated when the reader 10 is connected to a computer system 30, or during a read process. A dual colour LED 14A can turn green when reading the tag, with the LED turning red when writing to the tag.

Multiple Tags

The system can be adapted to write to multiple tags, such that the information and key selection process need only be performed a single time, with the processor repeating steps 1100 each time the trigger 13A is depressed. In this case, software can prompt for the number of tags to be programmed which will then allow successive actuations of the trigger until all tags are programmed after which the next trigger will cause the gun to revert to read only mode, and purge the memory 12.

Active Tags

Whilst the above examples focus on the use of passive tags, which are powered by inductive coupling with the reader, this is not essential and active tags having an internal power source may be used. In this instance, the tags are advantageous in that they generally have an enhanced range of operation as there is no requirement to inductively couple power from the reader to the tag. In general such tags only have a limited battery lifespan. However, in the case of registration label applications this is not a major issue as the registration label will in any event be replaced on an annual basis, and the lifespan of the battery will therefore typically far exceed the label life.

In examples in which active tags are used, then the tags may implement memory with a smaller memory capacity. The purpose behind this is to minimize the amount of information that is transferred from the tag to the reader, which in turn increases battery life. In this instance, it may therefore be typical to store only a unique identifier in the tag memory, which is then used to cross reference the remote database allowing relevant information to be viewed. In this instance, whilst any unique identifier may be used, to avoid identifier duplication, a unique identifier based on registration information, such as the vehicle VIN can be used.

Power Supply

When connected to the computer system, for example via a USB connection, power for the reader can be drawn from the computer. Otherwise a battery will be provided such as 9 volt alkaline battery. Alternately an AC power supply can be used.

To save power, the reader will typically turn on automatically if the trigger or the scroll button is actuated and automatically turn off if not used for 3 minutes.

Encryption

In one example, all data written to the tag is 128 bit AES encrypted and then locked so it is impossible to erase. The encryption is based on a 64 bit secret key. Each reader 10 will typically be capable of storing a number of secret keys enabling the reader to be used for a corresponding number of different applications.

In one example, the encryption system uses a Unique ID of the tag 1, determined during the initial detection of the tag 1, and combines this with the secret key of the Reader/Writer to create a “hash” key based on the encryption algorithm. This means that only a device with the correct secret key and encryption algorithm will be able read and decipher the tag.

As previously mentioned dissemination of the secret keys is restricted to control access to the information, thereby helping to ensure appropriate security of the information stored on the tags. In order to control dissemination of the tags an authority may be to supply secret keys, with it being necessary for the owners of the readers to undergo some form of authorization and authentication with the registration authority in order to be obtain the keys. The authority will then operate to record the secret key into the memory 12 of the tag reader 10, via a secure connection.

Alternatively the secret key may be generated locally, within the computer system 30, or the reader 10, again providing further control over dissemination.

However, use of a relevant authority allows common secret keys to be more easily provided to a number of readers. This allows different readers within an organization, such as the Police force, to be programmed with the key centrally, thereby removing the burden from the Police force. Additionally, as some tags may want to be accessed via a number of different parties, in which case the authority may authorize the provision of the secret key to each party independently.

It will be appreciated from this that each secret key will typically associated with a respective type of information, or use scenario, examples of which will be described in more detail below. A further feature is that different encryption keys may be associated with different access levels. This provides additional security to information such that different users of the system are only able to decrypt different parts of the information.

Remote Shutdown

In order to further prevent unauthorized use of the system it is possible for the readers 10 to incorporate a remote shutdown system. In particular, the remote shutdown system may be used in the event that a reader 10 is stolen. In this particular instance the reader 10 will typically include GPRS functionality or similar to allow wireless communication to be performed with a remote computer system. In this case, when a reader 10 is reported stolen the remote computer system can transfer predetermined commands to the reader 10 causing the processor 11 to shutdown the reader 10 and purge the contents of the memory 12, thereby deleting any secret keys contained, and preventing further use of the device.

Additionally, the reader 10 may include a GPS system to allow the location of the reader 10 to be monitored, which in turn allows lost or stolen readers 10 to be recovered.

User Authentication

The nature of the operator ID can vary depending on the model of the reader 10, and the level of security desired.

The ID could include, for example, a PIN (Personal Identification Number), a password, a biometric signature of the operator, or the like. The manner in which the ID is generated and provided to the reader 10 will depend on the authentication mechanism used but may include for example scanning a thumb print to generate a biometric signature, entering a PIN number using the input 13, or the like.

Monolithic IC

It is possible for the processor 11 and the memory 12 provided in the reader 10 to be formed on a monolithic IC. The use of the monolithic IC avoids the need to transfer secret keys via the bus 19 which can represent a point of weakness in the security of the system.

In particular, if a reader 10 is stolen, then it is possible to monitor signals transferred via the bus 19 and use these to determine the secret keys stored within the device. The secret keys can then be used to decrypt the information provided on tags. However by utilizing a monolithic IC all transfer of the secret key is internal within a single chip and is therefore virtually impossible to derive by outside measurement of signals.

Read/Write Details

It is possible to encode information regarding the write and read processes, either within the tag 1, or the remote database 36.

For example, it is possible to utilize time stamping to record either when information is written to a tag 1 or read from the tag 1. In the former case the time stamp is typically included within the encoded data so that it may not be subsequently modified. The time stamp can then be used for a number of purposes, such as to indicate expiry dates of the information. In this later case as there is only limited space on a tag and a significant number of read events may occur, each time a tag is read the reader 10 is adapted to provide an indication of the unique tag ID to the remote database 36 which then stores this together with a time stamp indicating when the device tag was read.

The information may also include personal information regarding the operator of the reader 10 such that the user of the reader 10 can be subsequently identified.

Example Uses

It will be appreciated by persons skilled in the art that the above described registration process can also be modified for use in other circumstances, and in particular to any vehicle transfer, sale, or registration. Thus, whilst the example is specific to vehicle registration, the process can be modified to provide an audit trail of any post manufacture events relating to the car.

Thus, the tag stores a large amount of information that can be subsequently used in a variety of manners. Thus in addition to providing registration information as discussed above, the information may be used to identify the vehicle at any stage during the vehicle's life.

As an additional function, it is desirable in many cases to have RFID tags 1 embedded within the asset itself so that they are not provided on a sticker. This may include for example locating RFID chips at a number of different locations on the vehicle thereby allowing additional checks to be performed. This allows information such as the vehicle VIN, chasse number, or the like to be encrypted on the tag and stored. This allows additional test of vehicles to be performed by appropriate authorities.

Persons skilled in the art will appreciate that numerous variations and modifications will become apparent. All such variations and modifications which become apparent to persons skilled in the art, should be considered to fall within the spirit and scope that the invention broadly appearing before described.

For example, whilst the above described processes are described with respect to vehicles, it will be appreciated that the techniques may be applied to any situation in which it is desired to register an asset using a label.

1. A method of providing a registration label for a vehicle, the method including, in a processing system:
a) determining registration information, the registration information being at least partially indicative of an identity of the vehicle; and,
b) generating the label by:
i) causing printed information to be provided on the label, the label including a tag having a tag data store, and the printed information being at least partially indicative of the registration information; and,
ii) causing tag data to be stored in the tag data store, the tag data being at least partially indicative of the registration information, the label being provided to allow the label to be attached to the vehicle, thereby allowing at least some of the tag data to be retrieved from the label using a suitable reader.

2. A method according to claim 1, wherein the method includes, in the processing system, locking the tag data to thereby prevent subsequent alteration of the tag data.

3. A method according to claim 1, wherein the method includes, in the processing system, generating the tag data by encrypting at least part of the registration information such that the tag data can only be decrypted using a predetermined secret key.

4. A method according to claim 1, wherein the method includes, in the processing system:
a) determining a secret key associated with the registration information; and,
b) generating the tag data using the registration information and the secret key.

5. A method according to claim 1, wherein the method includes, in the processing system:
a) determining an operator identifier indicative of an identity of an operator;
b) authenticating the operator using the operator identifier; and,
c) generating the label in response to a successful authentication.

6. A method according to claim 5, wherein the method includes, in the processing system:
a) receiving the operator identifier from the operator;
b) comparing the operator identifier to a number of predetermined operator identifiers stored in a database; and,
c) authenticating the operator in response to a successful comparison.

7. A method according to claim 5, wherein the operator identifier includes at least one of:
a) a bio-metric signature;
b) a password; and,
c) a PIN.

8. A method according to claim 1, wherein the method includes, in the processing system:
a) determining at least one access level associated with the registration information; and,
b) generating tag data in accordance with at least one access level.

9. A method according to claim 1, wherein the method includes, in the processing system:
a) determining additional information to be stored in a remote database, the additional information being at least partially indicative of the registration information;
b) storing the additional information in the remote database;
c) generating an information identifier indicative of the location of the additional information in the remote database; and,
d) generating the tag data in accordance with the information identifier.

10. A method according to claim 1, wherein the method includes generating tag data including:
a) a payload, the payload including at least some of the registration information encrypted using a secret key; and,
b) a header, the header being indicative of the secret key.

11. A method according to claim 1, wherein the tag data is at least partially encrypted, and wherein the method includes, providing secret keys to at least one entity authorized to read the tag data from the tag.

12. A method according to claim 1, wherein the tag data is at least partially encrypted, and wherein at least one of generation and distribution of secret keys is controlled by a trusted entity, and wherein the method includes, in the processing system, obtaining the secret key from the trusted entity.

13. A method according to claim 1, wherein the method includes, in the processing system, at least one of:
a) generating the secret key in accordance with a predetermined algorithm; and,
b) determining the secret key from a trusted third party.

14. A method according to claim 1, wherein the method includes, in the processing system:
a) generating one or more markings at least partially indicative of the registration information; and,
b) causing the markings to be applied to the label, the markings being substantially invisible to the unaided eye, the markings being at least partially indicative of the registration information.

15. A method according to claim 1, wherein the method includes, in the processing system, causing a tag reader to generate a write signal, the write signal being modulated in accordance with the tag data and the tag being responsive to the write signal to store the tag data in the tag data store.

16. A method according to claim 15, wherein the processing system is at least one of:
a) part of the tag reader; and,
b) connected to the tag reader via a communications system.

17. A method according to claim 1, wherein the processing system includes a printer for printing the printed information.

18. A method according to claim 1, wherein the registration information includes at least one of:
a) details of an entity performing the registration;
b) registration limitations;
c) vehicle details;
d) vehicle owner details;
e) purchase information;
f) insurance information; and,
g) outstanding infringement notifications.

19. Apparatus for providing a registration label for a vehicle, the apparatus including a processing system:
a) determining registration information, the registration information being at least partially indicative of an identity of the vehicle; and,
b) generating a label by:
i) causing printed information to be provided on the label, the label including a tag having a tag data store, and the printed information being at least partially indicative of the registration information; and,
ii) causing tag data to be stored in the tag data store, the tag data being at least partially indicative of the registration information, the label being provided to allow the label to be attached to the vehicle, thereby allowing at least some of the tag data to be retrieved from the label using a suitable reader.

20. Apparatus according to claim 19, wherein the apparatus includes a tag reader for generating a write signal, the write signal being modulated in accordance with the tag data and the tag being responsive to the write signal to store the tag data in the tag data store.

21. Apparatus according to claim 20, wherein the processing system is at least one of:
a) part of the tag reader; and,
b) coupled to the tag reader via a communications system.

22. Apparatus according to claim 19, wherein the apparatus includes:
a) an input for receiving an operator identifier indicative of an identity of the operator;
b) a modulator for generating a write signal; and,
c) a processor for:
i) authenticating the operator using the operator identifier; and,
ii) in response to a successful authentication:
(1) determining registration information;
(2) generating tag data using the registration information and a secret key; and
(3) causing the modulator to generate a write signal, the write signal being modulated in accordance with the tag data, the tag being responsive to the write signal to store the tag data in a tag data store.

23. (canceled)

23. A vehicle registration label including:
a) a substrate having at least one adhesive portion for allowing the substrate to be attached to a vehicle;
b) printed information provided on the label, the printed information being at least partially indicative of registration information; and,
c) a tag having a tag data store, the tag data store storing tag data at least partially indicative of the registration information.

24. A label according to claim 23, wherein the label includes at least one security feature for detecting tampering.

25. A label according to claim 24, wherein the label includes first and second adhesively connected substrate portions, such that when the substrate is attached to a vehicle, an attempt to remove the substrate from the vehicle causes separation of the first and second substrate portions.

26. A label according to claim 25, wherein at least one of the first and second substrate portions includes a marked surface that is exposed when the first and second substrate portions are separated, the marking being indicative of attempted label removal.

27. A label according to claim 25, wherein the tag is coupled to a tag antenna, and wherein:
a) the tag is coupled to the first substrate portion; and,
b) the antenna is coupled to the second substrate portion, such that separation of the first and second substrate portions disconnects the antenna from the tag.

28. A label according to claim 24, wherein the tag is embedded within a material having predetermined optical properties, and wherein deformation of the label causes a change in the optical properties of the material to thereby indicate tampering with the label.

29. A label according to claim 24, wherein the tag includes dye capsules embedded in the material, the dye capsules being adapted to release dye upon deformation of the label.

30. A label according to claim 23, wherein the registration label includes one or more markings substantially invisible to the unaided eye, the markings being at least partially indicative of the registration information.

32. (canceled)

31. A method of performing an action relating to a vehicle having a registration label including a tag having a tag data store, the method including, in a processing system:
a) determining tag data from the tag data store, the tag data being at least partially indicative of registration information; and,
b) determining at least one action; and,
c) performing, using at least some of the registration information, the at least one action.

32. A method according to claim 31, wherein the tag data is formed by encrypting at least part of the registration information, and wherein the method includes, in the processing system:
a) determining a secret key; and,
b) using the secret key to at least partially decrypt the tag data.

33. A method according to claim 31, wherein the method includes, in the processing system:
a) determining an operator identifier indicative of an identity of the operator;
b) authenticating the operator using the operator identifier; and,
c) in response to a successful authentication, performing at least one of:
i) determining the tag data;
ii) decrypting the tag data; and,
iii) performing the at least one action.

34. A method according to claim 33, wherein the method includes, in the tag reader:
a) receiving the operator identifier from the operator;
b) comparing the operator identifier to a number of predetermined operator identifiers stored in a database; and,
c) authenticating the operator in response to a successful comparison.

35. A method according to claim 33, wherein the operator identifier includes at: least one of:
a) a biometric signature;
b) a password; and,
c) a PIN.

36. A method according to claim 33, wherein the method includes, in the processing system:
a) determining from the decoded information at least one information access level;
b) determining, using the operator identifier and from operator details stored in a database, one or more operator access levels;
c) comparing the information access levels to the operator access levels; and,
d) selectively displaying the information in accordance with the results of the comparison.

37. A method according to claim 31, wherein the method includes, in the processing system: a) determining an information identifier from the decoded information; and, b) using the information identifier to access additional information stored in a remote database.

38. A method according to claim 31, wherein the tag data includes: a) a payload, the payload including the information encrypted using the secret key; and, b) a header, the header being indicative of the secret key, and wherein method includes, in the processing system: i) determining, from the header, an indication of the secret key; ii) determining the secret key using the secret key indication; and, iii) decrypting the payload using the secret key.

39. A method according to claim 31, wherein the method includes, in the processing system, at least one of: a) generating the secret key in accordance with a predetermined algorithm; and, b) determining the secret key from a trusted third party.

40. A method according to claim 31, wherein the method includes, in the processing system:
a) determining at least one action associated with the registration information; and,
b) performing the at least one action at least in part in accordance with input commands from an operator.

41. A method according to claim 31, wherein the method includes, in the processing system, causing a tag reader to:
a) generate a read signal, the tag being responsive to the read signal to modulate the read signal in accordance with tag data stored in a tag data store; and,
b) detect modulation of the read signal to thereby determine the tag data.

42. A method according to claim 43, wherein the processing system is at least one of:
a) part of the tag reader; and,
b) coupled to the tag reader using a communications system.

43. A method according to claim 31, wherein the method includes, in the processing system, causing markings on the label to be exposed using a source of non-visible radiation, the markings being responsive to the non-visible radiation to generate visible radiation and the markings being indicative of the registration information.

44. A method according to claim 31, wherein the action includes at least one of:
a) issuing infringement notices;
b) identifying stolen property; and,
c) identifying a vehicle owner.

47. (canceled)

45. Apparatus for performing an action relating to a vehicle having a registration label including a tag having a tag data store, the apparatus including a processing system for:
a) determining tag data from the tag data store, the tag data being at least partially indicative of registration information; and,
b) determining at least one action; and,
c) performing, using at least some of the registration information, the at least one action.

46. Apparatus according to claim 45, wherein the apparatus includes a tag reader for:
a) generating a read signal, the tag being responsive to the read signal to modulate the read signal in accordance with tag data stored in a tag data store; and,
b) detecting modulation of the read signal to thereby determine the tag data.

47. Apparatus according to claim 46, wherein the processing system is at least one of:
a) part of the tag reader; and,
b) coupled to the tag reader via a communications system.

48. Apparatus according to claim 45, wherein the apparatus includes:
a) an input;
b) a modulator for generating a read signal; and,
c) a processor for:
i) authenticating the operator using an operator identifier received via the input; and,
ii) in response to a successful authentication:
(1) causing the modulator to generate a read signal, the tag being responsive to the read signal to modulate the read signal in accordance with tag data stored in a tag data store;
(2) determine, using modulation of the read signal, the tag data;
(3) determining, using the tag data, a secret key; and
(4) decoding the tag data using the secret key.

52. (canceled)

49. A method according to claim 1, wherein the method includes periodically providing a new registration label, the new registration label having printed information and tag data including at least part of updated registration details.
